(19) United States
(12) Patent Application Publication
(10) Pub. No.: US 2006/0106543 A1
(43) Pub. Date: May 18, 2006

(54) Method for analyzing effectiveness of pharmaceutical preparation

(76) Inventors: Gustavo Deco, Vilassar de Mar (ES); Norbert Galm, Zorneding (DE); Martin Stetter, Munchen (DE)

Correspondence Address: STAAS & HALSEY LLP, SUITE 700, 1201 NEW YORK AVENUE, N.W., WASHINGTON, DC, 20005, US

(21) Appl. No.: 10/524,000

(22) PCT Filed: Jul. 24, 2003
(86) PCT No.: PCT/DE03/02497

§ 371 Date: Oct. 11, 2005

(30) Foreign Application Priority Data
Aug. 9, 2002 (DE) 102 36 630.6

(51) Int. Cl. G06F 19/00

(52) U.S. Cl. 702/19

(57) ABSTRACT

The activity of a pharmaceutical preparation or medicament on a neuronal structure is analyzed by subjecting a neuronal structure to the influence of a pharmaceutical preparation. Signals describing neuronal activities in the neuronal structure under the influence of the pharmaceutical preparation are detected and statistically evaluated to determine indicators for the neuronal structure under the influence of the pharmaceutical preparation. The indicators describe the activity of the pharmaceutical preparation.

### CROSS REFERENCE TO RELATED APPLICATIONS

This application is based on and hereby claims priority to German Application No. 102 366 30.6 filed on Aug. 9, 2002, the contents of which are hereby incorporated by reference.

### BACKGROUND OF THE INVENTION

1. Field of the Invention

The invention relates to an analysis of the effectiveness of a pharmaceutical preparation or medical preparation.

2. Description of the Related Art

An analysis of the effectiveness of a new medical preparation or new medicine as part of an approval procedure is known from Arzneimittelforschung und-entwicklung (Pharmaceutical research and development), available on Aug. 06, 2002 at the medicine worldwide website in Germany (www.m-ww.de) on the pages devoted to “Pharmakologie Pharmaforschung”.

During an approval procedure of this kind the new medicine requiring approval passes through different (test) phases, phase 1 to phase 3, within which the effectiveness of the new medicine requiring approval in combating a specific disease has to be demonstrated. A further object of an approval procedure of this kind is to examine side-effects of the new medicine requiring approval as well as to test the effectiveness of the new medicine requiring approval in comparison with other similarly effective medicines.

The effectiveness tests are mostly conducted on the basis of studies carried out on test participants to whom the new medicine requiring approval is administered. The effectiveness of the new medicine is assessed on the basis of results from interviews, psychological tests and behavioral studies that are conducted with the test participants.

A disadvantage with effectiveness tests of this type is that they only provide or permit a qualitative assessment of the effectiveness of the new medicine, and furthermore this assessment is characterized by a high degree of subjectivity.

An analysis of neuronal activities in neuronal sites, in this case neuronal or nerve structures in areas of a patient's brain, is known from A. R. McIntosh et al., Structural Equation Modeling and Its Application to Network Analysis in Functional Brain Imaging, Human Brain Mapping, 2:2-22, 1994.

Knowledge of the principle of operation of a neuronal site as well as of the interaction of neuronal sites is fundamental to a functional magnetic resonance tomography or fMRI (functional Magnetic Resonance Imaging) technology as described in, e.g., A. W. Toga and J. C. Maziotta (publisher), Brain Mapping: The Methods, chapter 9, M. S. Cohen, “Rapid MRI and Functional Applications”, Academic Press, 1996, pp. 223-255, which is a further development of the known magnetic resonance tomography.

The previously known magnetic resonance tomography (MR for short) is an image-generating technique which generates cross-sectional images of the human body without the use of harmful X-ray radiation.

Instead, MR takes advantage of the behavior of bodily tissue when exposed to a strong magnetic field. This enables pathological changes in the bodily tissue, for example in the brain or spinal cord, to be detected.

Functional disturbances in the bodily tissue, more particularly in the brain of a patient, cannot be detected using known magnetic resonance tomography, however.

Functional magnetic resonance tomography, or fMRI technology, a further development of MR, could help solve this problem.

Using fMRI technology, the neuronal activity in areas of the brain of a patient can be measured indirectly. The variable measured in this case is what is known as the BOLD (Blood Oxygenation Level Dependent) signal in individual areas of the brain, which signal is related to the neuronal activity in the respective areas.

Between the neuronal activities in the sites there exist dependencies, including structurally related dependencies, that is to say dependencies which arise, among other things, from structures in the brain, i.e. from neuronal linkages between nerve cells or nerve structures.

The result of the fMRI measurements shows the progression of the activity of individual neuronal sites over a certain period of time, for example during cognitive processes as a result of certain perception processes or motor tasks.

Functional disturbances, in this case in the brain, are therefore implicitly contained in the measured fMRI signals.

Previously known methods for analyzing the fMRI measurements enable functional relationships between different brain sites to be detected during specific, predetermined tasks, such as the cited perception processes or motor tasks, which functional relationships are referred to as functional connectivity.

A known analysis method of this kind for detecting functional connectivity, termed “Structural Equation Modeling” (SEM), is disclosed for example in the article by A. R. McIntosh et al. cited above. A further such SEM is described below.

The purpose of the below-described analysis method is the above-described detection of functional connections between different brain sites during certain perception processes or motor tasks, in short the derivation of functional neuronal structures associated with special tests.

This known analysis method is based on a predefined model of a brain, i.e. a predefined brain architecture.

This brain architecture predetermined a priori from a prior knowledge defines general functional and/or spatial dependencies between certain brain sites in the form of a so-call correlation matrix S.

The correlation matrix S has a defined (column/row) form or structure corresponding to the predetermined brain architecture and is accordingly occupied at certain (matrix) positions by so-called correlation strengths Sᵢ.

These correlation strengths Sᵢ describe functional dependencies in each case between two brain sites or, as the case may be, between the BOLD signals measured there and representing the neuronal activities there.

With this known analysis method the (variable) correlation strengths Sᵢ are now determined in such a way that statistical indicators which are derived from the fMRI measurements by this analysis method can be explained in the most meaningful manner. To put it another way, the sought correlation strengths Sᵢ are intended to be used to maximize a probability for an occurrence of the measured data, i.e. the fMRI measurement or the BOLD signals.

With this known analysis method a data point s=sₜ represents an averaged totality of all BOLD signals s1, . . . , sN of the individual n sites at a time t or over a time interval t (t=[1;T]).

The fMRI measurement has a plurality of such data points which characterize possibly different perception processes and/or motor tasks for which the corresponding BOLD signals were measured.

With the known analysis method, instead of the individual data points s1, s2, . . . , sT being analyzed directly, statistical indicators which are derived from the data points are evaluated.

For a statistical distribution of the data points s1, s2, . . . , sT, it is assumed that the distribution is fully described by a multivariable normal distribution, i.e. a first-order statistical distribution, having an average value μ and a covariance Σ:

$$P ( s \vert μ , Σ ) = \frac{1}{{\sqrt{2 π}}^{N} \cdot \vert Σ \vert} \cdot {ⅇ}^{- \frac{1}{2} {( s - μ )}^{′} {Σ}^{- 1} ( s - μ )} \qquad ( 1 )$$

For sufficiently long measurement series, the occurrence of the individual data points si from s1, s2, . . . , sT can be considered statistically independent.

The probability P=P(s1, . . . , sT|μ,Σ) for an occurrence of all the measured data points s1, . . . , sT can accordingly be written as:

$$\begin{matrix}P ( {s}_{1} , … , {s}_{T} \vert μ , Σ ) = {\prod }_{t = 1}^{T} P ( {s}_{t} \vert μ , Σ ) \\ = \frac{1}{{\sqrt{2 π}}^{NT} \cdot {\vert Σ \vert}^{T}} \cdot {ⅇ}^{- \frac{1}{2} {{Σ}_{t = 1}^{T} ( {s}_{t} - μ )}^{′} {Σ}^{- 1} ( {s}_{t} - μ )}\end{matrix} \qquad ( 2 )$$

In this case the unknown variables, the average value μ and the covariance Σ, are dependent exclusively on a (brain) model which describes the measurement data.

The model assumes a linear statistical connection between the individual BOLD signals:

$${s}_{i} = {\sum }_{j = 1}^{N} {S}_{ij} {s}_{j} + {ɛ}_{i} für i = 1 , … , N or s = Ss \div ɛ \qquad ( 3 )$$

where ε describes the external influence on the individual BOLD signals, such as a sensory input by sensory cells onto the sites of the brain that are being examined.

The influencing variables εi and εj affecting different sites i and j can be entirely correlated in this case.

Accordingly the model parameters to be specified are the correlation strengths Sᵢ of the underlying correlation matrix S, the average value με of the external influence s and the covariance Σε of ε.

On these depend the average value μ and die covariance Σ:
μ=μ(S, Σ_{ε})
Σ=Σ(S, Σ_{ε}) (4)

With the known analysis method the model parameters are now determined in such a way that the probability P=P(s1, . . . , sT|μ,Σ) given in (2) is maximized for the occurrence of the measurement data.

A method (optimization) of a known Maximum Likelihood Estimation as described in e.g., T. W. Anderson, An Introduction to Multivariable Statistical Analysis, chapter 3, John Wiley & Sons, Inc., New York, London, Sydney, 1994, pp. 44-57, is applied for this purpose.

Using the connections (4) in (2) yields an expression which is dependent on the correlation strengths Sᵢ, the average value με and the covariance Σε and which is maximized as a result of the optimization.

The optimization then leads to the sought correlation strengths Sᵢ between the BOLD signals.

These in turn then enable the detection of functional connections between different brain sites during certain perception processes or motor tasks (functional connectivity).

A software tool for an fMRI analysis method, an “fmri.pro”, is known from the description of the software “fmri.pro” that performs quantitative fMRI analysis, available on Sep. 07, 2001, at www.med.uni-muenchen.de. A device for performing the fMRI technique is known from the description of an fMRI device, available on Sep. 07, 2001, at www.unipublic.unizh.ch/campus/uni-news/2001/0147/fmri.html.

### SUMMARY OF THE INVENTION

An object of the invention is to specify a method for analyzing and assessing the effectiveness of a pharmaceutical preparation, the method enabling a quantified and objectivized evaluation of the effectiveness of the pharmaceutical preparation.

With the method for analyzing the effectiveness of a pharmaceutical preparation on a neuronal structure, which neuronal structure is described using correlation variables which describe a functional connection between neuronal sites of the neuronal structure, the neuronal structure is exposed to the influence of a pharmaceutical preparation.

Signals are measured which describe neuronal activities in the neuronal sites of the neuronal structure that is exposed to the influence of the pharmaceutical preparation.

These signals are evaluated using a statistical method, with changed correlation variables being determined for the neuronal structure that is exposed to the influence of the pharmaceutical preparation.

The changed correlation variables describe the effectiveness of the pharmaceutical preparation.

In this context the pharmaceutical preparation is understood to mean any type of chemical agent that is suitable for influencing the activity in a neuronal structure or of acting on the neuronal structure, for example pharmaceuticals for treating mental illnesses such as depression or Alzheimer's or for treating other physical ailments.

Effectiveness also implies not only an active strength, and therefore effectiveness in the narrower sense, but in addition a fundamental active principle of the pharmaceutical preparation, such as, for example, a place where it is active, complex interactions, in particular when there are multiple places of activity, active concepts and strategies, side-effects, as well as other influenced peripheral structures.

Thus, the following, for example, are implicitly contained in the changed correlation variables or can be read directly or indirectly therefrom:
the degree or level of the influence or effectiveness of the pharmaceutical preparation,
the place of activity or combined places of activity within the neuronal structure,
uninfluenced regions within the neuronal structure.

Seen clearly, the analysis and assessment of the effectiveness of a pharmaceutical preparation are based on an identification and evaluation of an activity pattern of a neuronal structure of a test participant, for example in a specific treatment state.

In this case an activity pattern is evaluated using a statistical method such as structural equation modeling, or SEM for short, which generates statistical characteristics or indicators such as the correlation variables. These characterize a complex excitation state of the neuronal structure and thus permit the evaluation and assessment of the effectiveness of the pharmaceutical preparation.

During the evaluation of an activity pattern a neuronal model of the neuronal structure is generated which is mirrored in a structure of the correlation variables.

An aspect of the analysis method according to the invention that reveals itself as particularly advantageous is that it allows a quantitative evaluation of the effectiveness of a pharmaceutical preparation, specifically through the statistical characteristics or indicators such as the correlation variables.

A further advantage with the analysis method is that it enables an identification of global neuronal mechanisms that are influenced or, as the case may be, caused by the pharmaceutical preparation, e.g. the activity, the connectivity or a modulation of neuronal structures.

This also enables the testing of the medicine during the clinical phases to be carried out quantitatively, more efficiently, more systematically and more quickly, as a result of which cost savings in the clinical trialing of the medicine and a shortening of the “time to market” can be achieved.

A computer program according to an aspect of the invention performs the analysis method described herein when the program is executed on a computer.

A computer program product according to an aspect of the invention may be stored on a machine-readable medium to perform the analysis method described herein when the program is executed on a computer.

The developments described hereinafter relate both to the method and to the computer program, as well as the computer program product.

The invention and the developments described in the following can be implemented both in software and in hardware, for example using a special electrical circuit.

Furthermore an implementation of the invention or a below-described development is possible by using a computer-readable storage medium on which a computer program is stored.

The invention or any development thereof described below can also be implemented by a computer program product which has a storage medium on which a computer program is stored.

In one development the signals are evaluated using a method based on structural equation modeling (SEM), wherein the changed correlation variables are determined. A SEM method is known from the article by A. R. McIntosh et al. cited above.

Furthermore the signals, which can be analog or digital signals, are determined by measurement, for example by measurement of BOLD signals, or alternatively they can also be read in from a memory and/or from a storage medium or from a D/A converter.

In one embodiment the neuronal sites are brain areas of a test participant.

The invention or its developments can also be used in the context of or in combination with an fMRI technology. In this case BOLD signals of a test participant are measured in the fMRI phase. The signals are then evaluated using the statistical method.

A method according to the invention or procedures derived therefrom may also be performed repeatedly in effectiveness studies, in particular long-term studies, of medicines. This usually happens in longer running test series.

Test series in general or effectiveness studies in general for studying pharmaceutical preparations are common and generally known.

In a first type of test series, the inventive procedure or procedures derived therefrom are performed in each case with different pharmaceutical preparations which are suitable for treating a specific illness. In this way it is possible to compare different pharmaceutical preparations quantitatively with one another with regard to their treatment efficacy and/or to test them against one another. In this case this is done by comparing the determined correlation variables of the individual tests.

At the same time the preparations compared with one another or tested against one another can be totally different preparations or else only differ in their material composition, for example such that active agent proportions in a preparation are increased or reduced.

It is also possible that at least one of the different preparations is a placebo.

In a different, second type of test series, the inventive procedure or procedures derived therefrom are likewise performed a plurality of times, with the neuronal structure in the multiple iterations being exposed to the influence of the same pharmaceutical preparation in each case. In this case each of the multiple iterations differs in terms of the duration of the influence of the pharmaceutical preparation on the neuronal structure.

As a result, the effect of a pharmaceutical preparation over time can be traced. In this case, too, the correlation variables determined from the measurements or signals of the respective moments in time are again compared with one another.

Furthermore the inventive procedure is also suitable for comparing totally different pharmaceutical preparations with one another, i.e. pharmaceutical preparations developed for different treatment purposes. This enables, for example, identical or similar active concepts to be identified in preparations which, per se, are completely different. Thus, for example, the same or similar activity patterns that are reflected in corresponding correlation variables can indicate identical or similar active concepts.

In order to increase the reliability of the results of analyses it is useful to use statistically averaged signals, obtained from signals mostly from a number of different test participants, as the signals.

### BRIEF DESCRIPTION OF THE DRAWINGS

These and other objects and advantages of the present invention will become more apparent and more readily appreciated from the following description of exemplary embodiment, taken in conjunction with the accompanying drawings of which:

FIG. 1 is a perspective view of a device for performing an fMRI scan according to an exemplary embodiment,

FIG. 2 is a flow diagram during an analysis of BOLD signals according to an exemplary embodiment,

FIG. 3 is a symbolic flow diagram of an exemplary embodiment which describes a procedure for determining the effectiveness of a pharmaceutical preparation using an fMRI.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

### Exemplary Embodiment: Assessment of the Effectiveness of a Pharmaceutical Preparation using Functional Magnetic Resonance Tomography Imaging (fMRI)

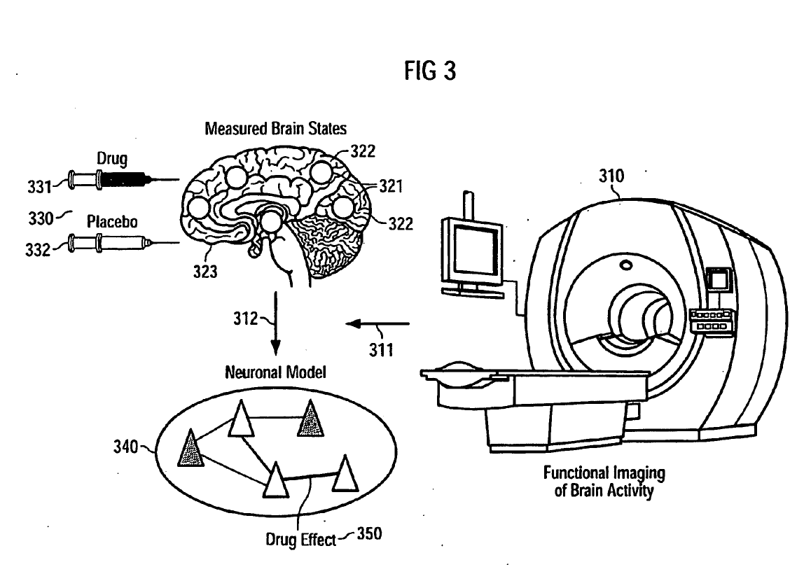

FIG. 3 shows in a schematic representation the procedure or the conceptual interaction of different functional components in determining and evaluating the effectiveness of a pharmaceutical preparation using functional magnetic resonance tomography imaging (fMRI).

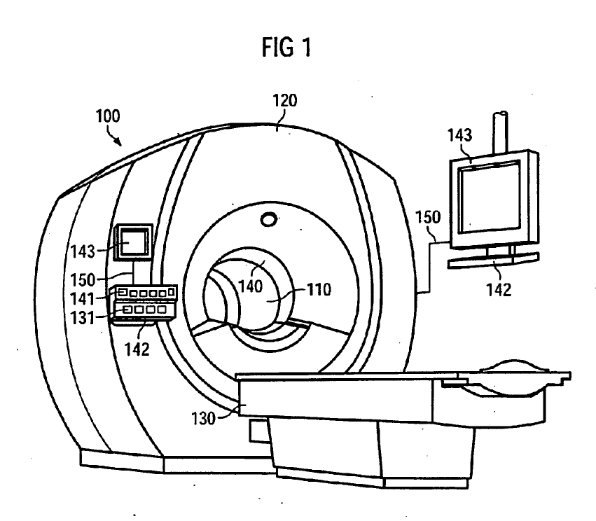

FIG. 3 shows a device 310 for performing functional magnetic resonance tomography imaging (fMRI for short), a functional magnetic resonance tomograph 310 (cf. FIG. 1, 100).

Using the magnetic resonance tomograph 310, neuronal activities 321 in sites 322 of a brain 323 of an individual or a patient are measured 311 and analyzed 312. Normally, a medical diagnosis is then derived from the resulting data.

In this case, however, as will be described below, the analysis results 340 of the fMRI are used for evaluating the effectiveness of a newly developed pharmaceutical or a new medicine 350.

The medicine to be evaluated in this case is a newly developed drug 331 for the treatment of Alzheimer's disease.

The evaluation of the drug 331 is carried out as part of a clinical study 330. A study of this kind within the context of an approval procedure for a new medicine and a basic method of proceeding in such a study, in particular how to handle test participants and the administering of test preparations, are known from the medicine worldwide web page cited above.

The present study has two stages:

In stage 1, two groups of individuals, namely selected Alzheimer patients and healthy test participants, are tested against each other, with the new drug being dispensed neither to the Alzheimer patients nor to the healthy test participants.

“Tested” in this context means that all the participants in the study are subjected in turn to an fMRI scan. The fMRI measurements obtained from the two groups are evaluated as described below, with so-called correlation variables being determined along with other information.

On the basis of the results, in particular of the correlation variables, structural and/or functional differences in the brains of the Alzheimer patients are determined as compared with those of the healthy test participants.

Stage 2 of the study is now performed only with the Alzheimer patients. Preparations 330 are administered to the patients, whereby some of the preparations are the new drug 331, whereas the others are a placebo 332.

After the preparations 330 have been administered, further fMRI measurements are carried out on the Alzheimer patients 311, except that this time those Alzheimer patients to whom the new drug was administered are tested against the recipients of the placebo.

These further fMRI measurements are evaluated in the same way as in stage 1, with the correlation variables also being determined once again.

On the basis of these results, changes in the brains of the Alzheimer patients treated with the drug are determined compared to those of the recipients of the placebo.

In this case the level and type of changes, i.e. the level and type of the changes in the values of the correlation variables, indicate a quantifiable effect or the effectiveness of the drug being tested.

Thus, for example, significant changes in the correlation variables point to a high degree of effectiveness of the test preparation. Since correlation variables are directly related to local brain sites, conclusions can also be drawn about specific active places in the brain. Positive, i.e. healing, effects are reflected in changes in correlation variables in the direction of the correlation variables of healthy test participants.

It should be noted that during the fMRI measurements carried out, the test individuals have to perform complex cognitive tasks and/or motor tasks.

FIG. 1 shows the device 100 for performing functional magnetic resonance tomography imaging (fMRI), a functional magnetic resonance tomograph 100 (FIG. 3, 310).

The basic principles of fMRI technology, which is a further development of the known magnetic resonance tomography, are known from the chapter on “Rapid MRI and Functional Applications by M. S. Cohen cited above.

The magnetic resonance tomograph 100 includes a closed tube 110 which is inserted into a magnet 120 in such a way that the latter generates a strong magnetic field in the tube 110.

The magnetic resonance tomograph 100 further includes a patient table 130 which can be moved into the tube 110 and on which a patient is placed during an examination.

In addition the magnetic resonance tomograph 100 includes a control device 131 which enables the patient table 130 to be monitored and controlled during the examination, allowing, for example, a controlled introduction of the patient table 130 into the tube 120.

As further components, the magnetic resonance tomograph 100 includes a measuring device 140 for measuring BOLD (Blood Oxygenation Level Dependent) signals, an associated evaluation device 141 for evaluating the measured BOLD signals, in this case a high-performance computer, and also a control and/or interaction device 142 for operating personnel as well as a display device 143 for displaying the results of an examination.

The components of the magnetic resonance tomograph 100 are functionally interconnected, for example by signal or data lines 150 via which data and signals can be transmitted.

The functional magnetic resonance tomograph 100 shown in FIG. 1 operates on the basis of fMRI technology and enables the neuronal activity in areas of the brain of a patient to be measured and analyzed and a diagnosis to be derived therefrom.

Toward that end the measuring device 140 is used to measure the BOLD (Blood Oxygenation Level Dependent) signal in discrete, selected areas of the brain of the patient, which signal is related to the neuronal activity in the respective area.

The results of such fMRI measurements show the progression of the activity of the individual brain areas over a certain period, for example during cognitive processes as a result of specific perception processes or motor tasks which are to be performed by the patient during an examination.

Irregularities, such as functional disturbances, in the brain of the patient are thus implicitly contained in the measured fMRI signals.

The evaluation device 141 which provides or performs a new analysis method is used to analyze the fMRI measurements, i.e. the BOLD signals measured in individual areas of the brain.

In this case this new analysis method represents an improved further development of the known analysis method described above and based on structural equation modeling the article by A. R. McIntosh et al. cited above.

With the new analysis method the brain activity is determined in the form of corresponding activation patterns in the examined areas in the brain and/or connections between activation patterns in the examined areas and from this conclusions are drawn directly about “normal” activity patterns or excitation states in the brain and also about functional disturbances in the brain and their causes.

The new analysis method provided by the evaluation device 140 is based on an extended and more flexible model of the brain, the neuronal structures in the brain and their behavior, in particular their interaction (FIG. 3, 340), on the basis of which the measured BOLD signal is analyzed and evaluated.

Basics of the new analysis method and the model are explained below.

The results of or conclusions drawn from an examination are displayed on the display device 143 and can be processed further using the control and interaction device 142 in combination with the evaluation device 141. They also serve as a basis for a medical diagnosis as well as for the assessment of the effectiveness of a medicine (cf. FIG. 3).

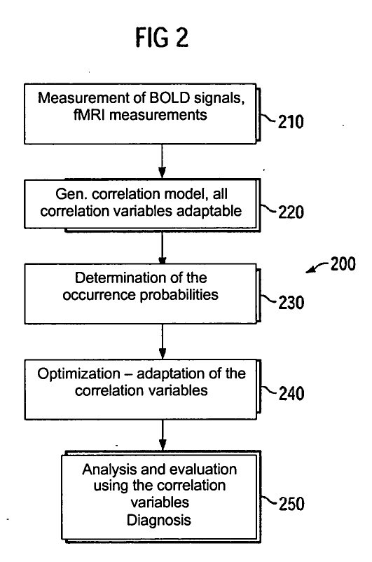

### Basics of the New Analysis Method (FIG. 2, 210 to 250)

It is pointed out that the new analysis method is an improved further development of the old analysis method described above. It therefore applies in the following that—unless stated to the contrary—old and new analysis method are consistent for these parts. If consistent parts are mentioned explicitly, they have the above previously used designation.

Using the new analysis method 200, the fMRI measurements (210), i.e. the BOLD signals in examined brain areas of a patient, are analyzed (210 to 250) and/or compared with reference fMRI measurements. This enables immediate conclusions to be drawn about “normal” activity patterns or excitation states in the brain and also about functional disturbances in the brain being examined and their causes.

The new analysis method 200, which generates statistical indicators such as statistical correlations between fMRI measurements in different brain areas, is based on an extended and more flexible mathematical model (220) of the brain (cf. FIG. 3, 340) based on the known mathematical model according to (3).

With this extended model (220) of the new analysis method, the correlation matrix S is occupied by variable correlation strengths Sᵢ at all (matrix) positions.

With the new analysis method 200, this time all—because also variable—correlation strengths Sᵢ are determined such that statistical indicators which are determined from the fMRI measurements can be explained in the most meaningful way (210 to 250).

A data point s=sₜ represents the totality of all BOLD signals s1, . . . , sN of the individual n examined areas at a time t (or averaged over a time interval t) (t=[I;T]).

The fMRI measurement uses a plurality of such data points s1, s2, . . . , sT for different perception processes and/or motor tasks for which the corresponding BOLD signals were measured.

In contrast to the old known analysis method, in which a multivariable normal distribution was assumed for the statistical distribution of the data points, with the new analysis method 200 a weighted total of normal distributions is assumed for the statistical distribution (220).

$$P ( s \vert {C}_{1} , , {C}_{L} , {μ}_{1} , … {μ}_{L} , {Σ}_{1} , … , {Σ}_{L} ) = \frac{1}{{\sum }_{l = 1}^{L} {C}_{l}} \cdot {\sum }_{l = 1}^{L} \{ \frac{{C}_{l}}{{\sqrt{2 π}}^{N} \cdot \vert {Σ}_{l} \vert} \cdot {ⅇ}^{\frac{1}{2} {( s - {μ }_{l} )}^{′} {Σ}_{l}^{- 1} ( s - {μ}_{l} )} . \} \qquad ( 5 )$$

In this case the chosen statistical distribution and therefore also the correspondence of the probabilities P=P(s|C1, . . . , CL, μ1, . . . , μL, Σ1, . . . , ΣL) (230) (cf. (2)) for the occurrence of the measured data points s1, s2, . . . , sT are dependent on more or different parameters than the average value μ and the covariance Σ of the old known analysis method.

With the new analysis method 200, certain statistical variables which can be calculated for the chosen statistical distribution are now placed in relation to the model parameters, i.e. the correlation strengths Sᵢ, the average value με of the external influence μ and the covariance Σε of ε.

These include, among others, the average values μ1, . . . , μL, the covariances Σ1, . . . , ΣL and all moments and cumulants of the chosen higher-order distribution.

This results in an implicit relationship between the parameters of the statistical distribution and the model parameters to be determined, in this case taking account of the distribution (5) and the extended model based on the model according to (3).

$$μ = μ ( {C}_{1} , {C}_{L} , {μ}_{1} , … , {μ}_{L} , {Σ}_{1} , … , {Σ}_{L} ) \\ Σ = Σ ( {C}_{1} , … , {C}_{L} , {μ}_{1} , … , {μ}_{L} , {Σ}_{1} , … {Σ}_{L} ) \\ ⋮ \\ μ = μ ( S , {μ}_{ɛ} , μ ) \\ Σ = Σ ( S , {Σ}_{ɛ} Σ ) \qquad ( 6 )$$

As with the old known analysis method, in the new analysis method 200 the optimal model parameters are now determined in an analogous manner using the maximum likelihood estimation (in Chapter 3 of T. W. Anderson, cited above) by optimization or maximization of the probabilities (5) (240).

The basic principles of maximum likelihood estimation are described in Chapter 3 of T. W. Anderson (cited above).

The parameters to be taken into account for the optimization process are the parameters of the chosen higher-order statistical distribution, in this case the weighted total of normal distributions, the sought model parameters and the statistical variables, in this case the average value μ and the covariance Σ from (6) via which the relationships between the model parameters and the statistical distribution (5) were established.

The relationships from (6) are to be taken into account as subsidiary conditions during the optimization.

The optimization then leads to the sought correlation strengths Sᵢ which describe dependencies between the BOLD signals (s50) and are the basis of the further evaluation, such as in this case the assessment of the effectiveness of a medicine (250).

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-15. (canceled)

16. A method for analyzing effectiveness of a pharmaceutical preparation on a neuronal structure described using correlation variables in defining a functional connection between neuronal areas of the neuronal structure, comprising:
exposing the neuronal structure to influence of a pharmaceutical preparation;
measuring signals indicating neuronal activities in the neuronal areas of the neuronal structure exposed to the influence of the pharmaceutical preparation;
evaluating the signals using a statistical method, with changed correlation variables being determined for the neuronal structure exposed to the influence of the pharmaceutical preparation; and
indicating the effectiveness of the pharmaceutical preparation using the changed correlation variables.

17. The method as claimed in claim 16, wherein said evaluating of the signals uses a structural equation modeling method to determine the changed correlation variables.

18. The method as claimed in claim 17, wherein the signals are blood oxygenation level dependent signals.

19. The method as claimed in claim 18, wherein the neuronal areas are brain areas of a test participant.

20. The method as claimed in claim 19, used in functional magnetic resonance tomography technology, wherein said determining the signals includes measurement of the blood oxygenation level dependent signals for a test participant prior to said evaluating using the statistical method.

21. The method as claimed in claim 20, further comprising repeating said exposing, measuring, evaluating and indicating a plurality of times for different pharmaceutical preparations.

22. The method as claimed in claim 21, wherein the different preparations differ in material composition.

23. The method as claimed in claim 21, wherein at least one of the different preparations is a placebo.

24. The method as claimed in claim 20, further comprising repeating said exposing, measuring, evaluating and indicating a plurality of times using the same pharmaceutical preparation each time, but varying a duration of exposure of the neuronal structure to the influence of the pharmaceutical preparation.

25. The method as claimed in claim 24, wherein said evaluating includes statistically averaging the signals.

26. A computer-readable storage medium storing instructions to control a computer to perform a method for analyzing effectiveness of a pharmaceutical preparation on a neuronal structure described using correlation variables in defining a functional connection between neuronal areas of the neuronal structure, said method comprising:
exposing the neuronal structure to influence of a pharmaceutical preparation;
measuring signals indicating neuronal activities in the neuronal areas of the neuronal structure exposed to the influence of the pharmaceutical preparation;
evaluating the signals using a statistical method, with changed correlation variables being determined for the neuronal structure exposed to the influence of the pharmaceutical preparation; and
indicating the effectiveness of the pharmaceutical preparation using the changed correlation variables.

27. A computer program product comprising program code stored on a machine-readable medium for performing the method recited in claim 16 when the program code is executed on a computer.
